(19) United States
(12) Patent Application Publication
(10) Pub. No.: US 2012/0297726 A1
(43) Pub. Date: Nov. 29, 2012

(54) Decorative Molding With Film

(75) Inventors: Peter J. Ellis, Rochester Hills, MI (US); Haruhisa Kawase, Rochester Hills, MI (US); Avi Zohar, Thornhill (CA); Malcolm Ward, Bradford (CA)

(73) Assignee: MAGNA INTERNATIONAL INC., Aurora, ON (CA)

(21) Appl. No.: 13/576,717

(22) PCT Filed: Feb. 16, 2011
(86) PCT No.: PCT/US2011/024964

§ 371 Date: Aug. 2, 2012

Related U.S. Application Data
(60) Provisional application No. 61/338,234, filed on Feb. 16, 2010.

(51) Int. Cl. B60R 13/02; B32B 7/04

(52) U.S. Cl. 52/716.7; 156/91

(57) ABSTRACT

A molding for attachment to a flange portion includes a retention portion having first and second legs defining a channel for receiving the flange portion, and a support member coupled to the retention portion and movable relative thereto. The support member includes an outboard surface and an inboard surface. A film is disposed along the outboard surface of the support member. A clip is formed along and extends out from the first leg of the retention portion. The clip is engageable with the support member to lock the support member in place relative to the retention portion for positioning the film along the flange portion.

### CROSS-REFERENCE TO RELATED APPLICATION

This application claims priority to and all the benefits of U.S. Provisional Application No. 61/338,234 filed on Feb. 16, 2010 and entitled “Decorative Molding With Film.”

### BACKGROUND OF THE INVENTION

### Field of the Invention

The invention relates to moldings for motor vehicle doors. More particularly, the invention relates to a molding including a film disposed along a support member.

### SUMMARY

According to one aspect of the invention, a molding for attachment to a flange portion includes a retention portion having first and second legs defining a channel for receiving the flange portion, and a support member coupled to the retention portion and movable relative thereto. The support member includes an outboard surface and an inboard surface. A film is disposed along the outboard surface of the support member. A clip is formed along and extends out from the first leg of the retention portion. The clip is engageable with the support member to lock the support member in place relative to the retention portion to position the film along the flange portion.

### BRIEF DESCRIPTION OF THE DRAWINGS

The invention will be readily appreciated as the same becomes better understood by reference to the following detailed description when considered in connection with the accompanying drawings wherein:

FIG. 1 is a cross-sectional view of one embodiment of a molding; and

FIG. 2 is a cross-sectional view of the molding including a clip engaging a support member.

### DETAILED DESCRIPTION OF THE EMBODIMENTS

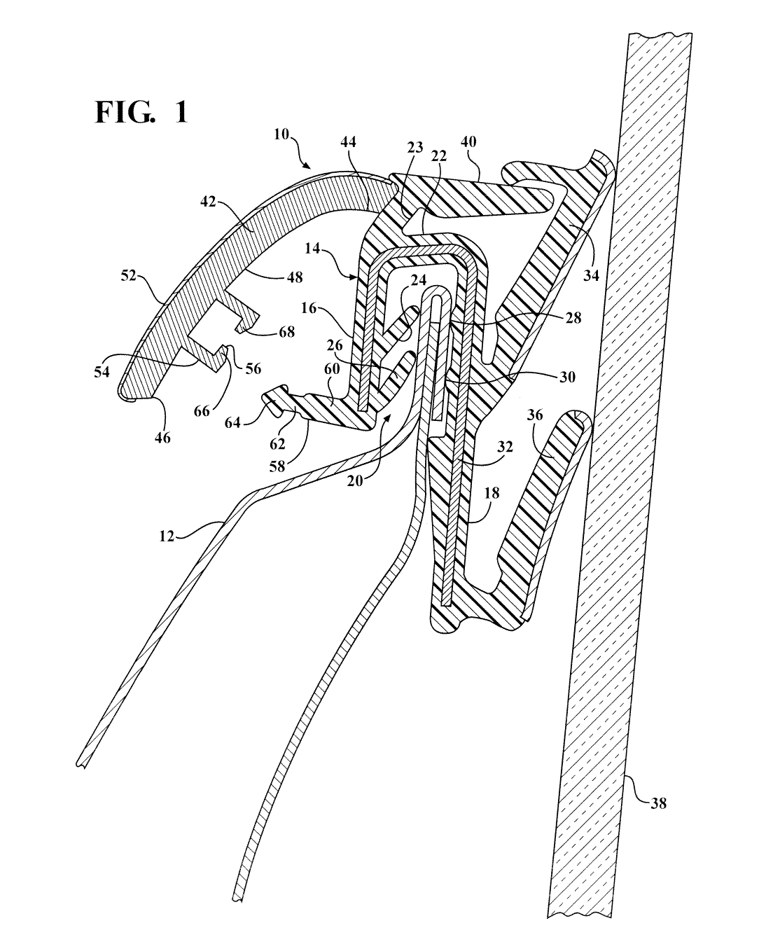

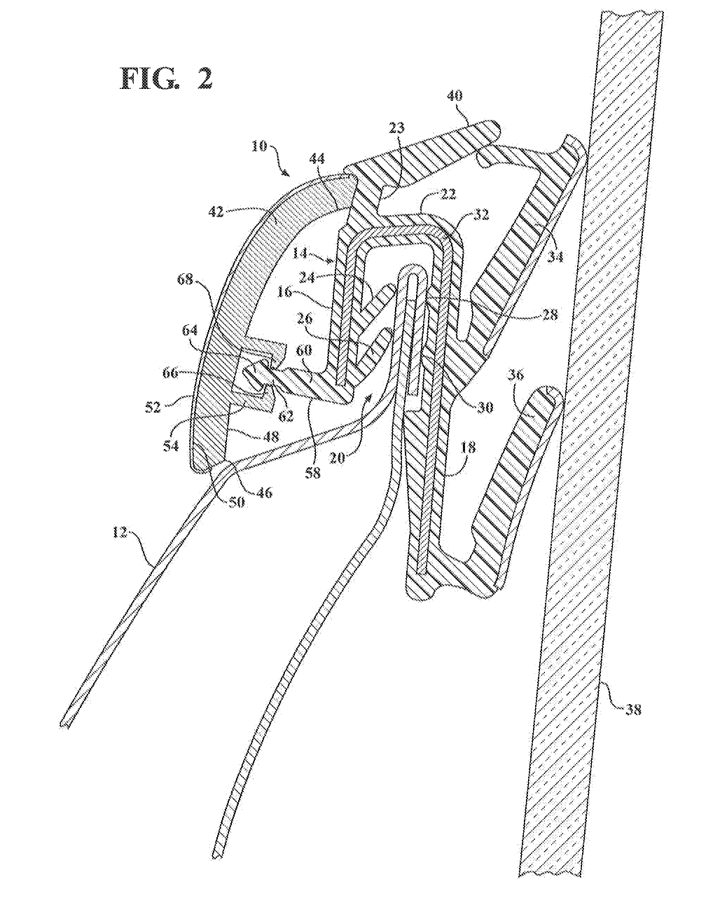

Referring to FIGS. 1 and 2, a molding, generally shown at 10, is provided for a motor vehicle component. In one embodiment, the molding 10 is an outer belt molding that is attached to a flange portion 12 of a motor vehicle door. It is, however, appreciated that the molding 10 may be any one of numerous moldings for positioning in any of a variety of locations along a motor vehicle.

The molding 10 includes a retention portion, generally indicated at 14, having first 16 and second 18 legs defining a channel 20 therebetween. A connecting wall portion 22 couples the first leg 16 to the second leg 18. A shoulder portion 23 abuts the connecting wall portion 22 and extends out therefrom. The retention portion 14 is formed from a generally soft thermoplastic material. In one embodiment, the retention portion 14 is formed from a generally soft plastic material having a durometer of approximately 67A. A pair of holding fingers 24, 26 extends out from the first leg 16, and first 28 and second 30 protrusions extend out from the second leg 18. The pair of holding fingers 24, 26 and the first 28 and second 30 protrusions retain the flange portion 12 on both sides thereof to securely maintain the molding 10 along the flange portion 12.

The molding 10 includes a carrier 32 embedded within the retention portion 14 of the molding 10 to provide a rigid support therefor. In one embodiment, the carrier 32 is formed from a flexible metal material, A pair of sealing lips 34, 36 extends out from the second leg 18 for sealing engagement with a window glass 38. A concealing lip 40 extends out from the shoulder portion 23 to hide the retention portion 14 of the molding 10 from view when the retention portion 14 is secured along the flange portion 12 of the motor vehicle door.

The molding 10 further includes a support member 42 extending between a first end 44 abutting the shoulder portion 23 and a second end 46. The support member 42 includes an inboard surface 48 and an outboard surface 50. The support. member 42 is formed from a hard plastic material, In one embodiment, the support member 42 has a durometer of approximately 401.

A film 52 is co-extruded with the molding 10 along the outboard surface 50 of the support member 42. The hard support member 42 allows for the smooth application of the film 52 along the outboard surface 50 during the extrusion process. The film 52 may be a chrome film, a high-gloss black film, or the like in order to provide the molding 10 with an aesthetically pleasing appearance.

The support member 42 also includes a locking member 54 formed along and extending out from the inboard surface 48. The locking member 54 defines an aperture 56. A clip 58 is formed along the first leg 16 of the retention portion 14 of the molding 10. The clip 58 includes a base portion 60, a neck 62, and an arrowhead 64. The clip 58 is received within the aperture 56 to adjust the molding 10 from an open configuration, shown in FIG. 1, to a closed configuration, shown in FIG. 2.

When the retention portion 14, the support member 42, and the film 52 are co-extruded to form the molding 10, the molding 10 is initially in the open configuration. When the molding 10 is ready to be applied to a motor vehicle component, such as the flange portion 12 of the motor vehicle door, an operator will guide the clip 58 into alignment with the aperture 56 and then push the clip 58 into the locking member 54 until the arrowhead 64 has moved completely through the aperture 56, as shown in FIG. 2. At this stage, the clip 64 is held within the locking member 54 by a pair of inner walls 66, 68 and the molding 10 is in the closed configuration.

The invention has been described in an illustrative manner. It is to he understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A molding for attachment to a flange portion, said molding comprising:
a retention portion having first and second legs defining a channel that is adapted for receiving the flange portion;
a support member coupled to said retention portion and movable relative thereto, said support member including an outboard surface and an inboard surface;
a film disposed along said outboard surface of said support member; and
a clip formed along and extending out from said first leg of said retention portion, said clip engageable with said support member to lock said support member in place relative to said retention portion to position said film in place along the flange portion.

2. A molding as set forth in claim I. including a connecting wall coupling said first and second legs together thereby defining said channel.

3. A molding as set forth in claim 2 including a shoulder portion extending out from said connecting wall away from said channel,

4. A molding as set forth in claim 3 wherein said support member extends between a first end coupled to said shoulder portion and a second end,

5. A molding as set forth in claim I including a locking member extending from said inboard surface of said support member, wherein said locking member is adapted to receive said clip to lock said support member in place relative to said retention portion.

6. A molding as set forth in claim 5 wherein said locking member defines an aperture between a pair of inner walls for receiving said clip therein.

7. A molding as set forth in claim 6 wherein said clip includes a base portion, a neck having a thickness less than said base portion, and an arrowhead having a thickness greater than said base portion, wherein said arrowhead is disposed through said aperture and said pair of inner walls engage said neck to retain said arrowhead within said locking member.

8. A molding as set forth in claim 3 including a concealing lip extending out from said shoulder portion to hide said retention portion when said molding is attached to the flange portion.

9. A molding as set forth in claim 1 including at least one holding finger extending out from said first leg toward said second leg, wherein said at least one holding finger is adapted for engaging the flange portion to securely maintain said molding along the flange portion.

10. A molding as set forth in claim 9 including at least one protrusion extending out from said second leg toward said first leg, wherein said at least one protrusion is adapted for engaging the flange portion to securely maintain said molding along the flange portion.

11. A molding as set forth in claim 1 including a carrier embedded within said retention portion to provide a rigid support therefor.

12. A molding as set forth in claim 1 wherein said retention portion is formed from a thermoplastic material having a durometer of about 67A.

13. A molding as set forth in claim 1 wherein said support member is formed from a plastic material having a durometer of approximately 40D.

14. A molding for attachment to a flange portion adjacent a window glass, said molding comprising:
a retention portion having first and second legs defining a channel that is adapted for receiving the flange portion;
at least one sealing lip extending out from said second leg away from said first leg, wherein said at least one sealing lip is adapted for sealing engagement with the window glass;
a support member coupled to said retention portion and movable relative thereto, said support member including an outboard surface and an inboard surface;
a film disposed along said outboard surface of said support member; and
a clip formed along and extending out from said first leg of said retention portion, said clip engageable with said support member to lock said support member in place relative to said retention portion to position said film in place along the flange portion.

15. A method of manufacturing a molding for attachment to a flange portion, the molding having a retention portion that is adapted for receiving the flange portion, a support member coupled to the retention portion and movable relative thereto, a film disposed along an outboard surface of the support member, and a clip extending out from the retention portion that is engageable with an inboard surface of the support member, the method including the steps of:
co-extruding the retention portion, the support member, and the film to form the molding with the support member in an open configuration;
applying the molding to the flange portion; and
pushing the clip into the locking member to retain the support member in a closed configuration.
